(19) United States
(12) Patent Application Publication
(10) Pub. No.: US 2024/0112081 A1
(43) Pub. Date: Apr. 4, 2024

(54) PREDICTION MODEL GENERATION APPARATUS, PREDICTION APPARATUS, PREDICTION MODEL GENERATION METHOD, PREDICTION METHOD, AND PROGRAM

(71) Applicant: NEC Corporation, Tokyo (JP)

(72) Inventors: Eiji Yumoto, Tokyo (JP); Masahiro Hayashitani, Tokyo (JP); Kosuke Nishihara, Tokyo (JP)

(73) Assignee: NEC Corporation, Tokyo (JP)

(21) Appl. No.: 18/201,999

(22) Filed: May 25, 2023

(30) Foreign Application Priority Data
Sep. 30, 2022 (JP) 2022-158495

(51) Int. Cl. G06N 20/00

(52) U.S. Cl. CPC G06N 20/00

(57) ABSTRACT

In order to attain an object of generating a prediction model which not only is capable of reducing a calculation load in a prediction phase but also has a good interpretability, a prediction model generation apparatus includes: a contribution degree calculation section that calculates, with use of a test data set different from a training data set used in training of a prediction model to be tested, a degree of contribution of each of a plurality of features to a prediction result, a value of the each of the plurality of features being inputted to the prediction model to be tested; a feature selection section that selects, on the basis of the degree of contribution of the each of the plurality of features, at least one feature from among the plurality of features; and a prediction model generation section that generates a new prediction model which, upon receiving input of a value of the at least one feature selected, outputs a prediction result.

### CROSS REFERENCE TO RELATED APPLICATIONS

This application is based upon and claims the benefit of priority from Japanese Patent Application No. 2022-158495 filed on Sep. 30, 2022, the disclosure of which is incorporated herein in its entirety by reference.

### TECHNICAL FIELD

The present invention relates to a technology for generating a prediction model and a technology for making a prediction with use of the prediction model.

### BACKGROUND ART

Patent Literature 1 discloses a system that predicts a worrying condition of a patient on the basis of feature values obtained from biological information of the patient. The system predicts a worrying condition of the patient with use of a prediction model which has been trained with use of, as training data, (i) feature values obtained from biological information of the patient as of when the patient was in a worrying condition in the past and (ii) feature values obtained from biological information of the patient as of when the patient was in a non-worrying condition in the past.

### CITATION LIST

### Patent Literature

### [Patent Literature 1]

International Publication No. WO 2019/044619

### SUMMARY OF INVENTION

### Technical Problem

In the system disclosed in Patent Literature 1, the feature values used as the training data for the prediction model are often values of a large number of features. This is because (i) the factor contributing to the worrying condition is unclear and (ii) thus values of a large number of features that can be a factor are used as training data. A prediction model generated from such training data has the problem of poor interpretability, in that it is unclear which feature has contributed to the prediction among the large number of features to which inputted values pertain. The prediction model also has the problem of a high calculation load in calculation of feature values in a prediction phase. These problems are not confined to a prediction model that predicts a worrying condition of a patient, but also apply to other prediction models that predict an event for which the factor is unclear.

An example aspect of the present invention is accomplished in view of the above problems. An example object of the invention is to provide a technology for generating a prediction model which not only is capable of reducing a calculation load in a prediction phase but also has a good interpretability.

A prediction model generation apparatus in accordance with an aspect of the present invention includes at least one processor, the at least one processor carrying out: a contribution degree calculation process of calculating, with use of a test data set different from a training data set used in training of a prediction model to be tested, a degree of contribution of each of a plurality of features to a prediction result, a value of the each of the plurality of features being inputted to the prediction model to be tested; a feature selection process of selecting, on the basis of the degree of contribution of the each of the plurality of features, at least one feature from among the plurality of features; and a prediction model generation process of generating a new prediction model which, upon receiving input of a value of the at least one feature selected, outputs a prediction result.

A prediction apparatus in accordance with an aspect of the present invention is a prediction apparatus which uses the new prediction model generated by the prediction model generation apparatus described above, the prediction apparatus including at least one processor that carries out: a feature value calculation process of calculating, on the basis of information obtained from a target of prediction, a value of the at least one feature selected; and a prediction process of inputting, to the new prediction model, the calculated value of the at least one feature to thereby output a prediction result related to the target of prediction.

A prediction model generation method in accordance with an aspect of the present invention includes: calculating, with use of a test data set different from a training data set used in training of a prediction model to be tested, a degree of contribution of each of a plurality of features to a prediction result, a value of the each of the plurality of features being inputted to the prediction model to be tested; selecting, on the basis of the degree of contribution of the each of the plurality of features, at least one feature from among the plurality of features; and generating a new prediction model which, upon receiving input of a value of the at least one feature selected, outputs a prediction result, the calculating, the selecting and the generating each being carried out by a computer.

A prediction method in accordance with an aspect of the present invention is a prediction method carried out by a computer with use of the new prediction model generated by the prediction model generation apparatus described above, the prediction method including: calculating, on the basis of information obtained from a target of prediction, a value of the at least one feature selected; and inputting, to the new prediction model, the calculated value of the at least one feature to thereby output a prediction result related to the target of prediction.

A non-transitory storage medium in accordance with an aspect of the present invention stores therein a program for causing a computer to carry out: a contribution degree calculation process of calculating, with use of a test data set different from a training data set used in training of a prediction model to be tested, a degree of contribution of each of a plurality of features to a prediction result, a value of the each of the plurality of features being inputted to the prediction model to be tested; a feature selection process of selecting, on the basis of the degree of contribution of the each of the plurality of features, at least one feature from among the plurality of features; and a prediction model generation process of generating a new prediction model which, upon receiving input of a value of the at least one feature selected, outputs a prediction result.

A non-transitory storage medium in accordance with an aspect of the present invention stores therein a program for causing a computer to function with use of the new prediction model generated by the prediction model generation apparatus described above, the program causing the computer to carry out: a feature value calculation process of calculating, on the basis of information obtained from a target of prediction, a value of the at least one feature selected; and a prediction process of inputting, to the new prediction model, the calculated value of the at least one feature to thereby output a prediction result related to the target of prediction.

### Advantageous Effects of Invention

An aspect of the present invention makes it possible to generate a prediction model which not only is capable of reducing a calculation load in a prediction phase but also has a good interpretability.

### BRIEF DESCRIPTION OF DRAWINGS

FIG. 1 is a block diagram illustrating a configuration of a prediction model generation apparatus in accordance with a first example embodiment of the present invention.

FIG. 2 is a flowchart illustrating a flow of a prediction model generation method in accordance with the first example embodiment of the present invention.

FIG. 3 is a block diagram illustrating a functional configuration of a prediction model generation apparatus in accordance with a second example embodiment of the present invention.

FIG. 4 is a flowchart illustrating a flow of a prediction model generation method in accordance with the second example embodiment of the present invention.

FIG. 5 is a view schematically illustrating each step of the prediction model generation method in accordance with the second example embodiment of the present invention.

FIG. 6 is a block diagram illustrating a configuration of a prediction model generation apparatus in accordance with a third example embodiment of the present invention.

FIG. 7 is a flowchart illustrating a flow of a prediction model generation method in accordance with the third example embodiment of the present invention.

FIG. 8 is a block diagram illustrating an example of a hardware configuration of an apparatus in accordance with each of the example embodiments of the present invention.

### EXAMPLE EMBODIMENTS

In the description below, the term “training data set” refers to a data set used in training of a prediction model. The term “test data set” refers to a data set used in performance evaluation of a prediction model.

### First Example Embodiment

The following will discuss in detail a first example embodiment of the present invention, with reference to drawings. The present example embodiment is a basic form of example embodiments described later.

(Configuration of Prediction Model Generation Apparatus 1)

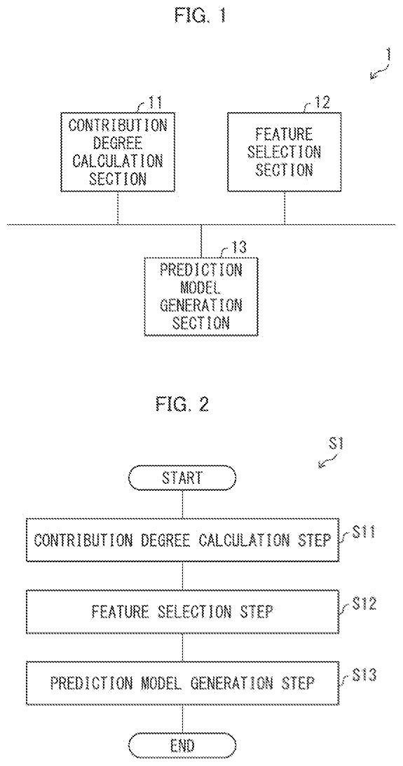

The following will discuss a configuration of a prediction model generation apparatus 1 in accordance with the present example embodiment, with reference to FIG. 1. FIG. 1 is a block diagram illustrating a configuration of the prediction model generation apparatus 1. As illustrated in FIG. 1, the prediction model generation apparatus 1 includes a contribution degree calculation section 11, a feature selection section 12, and a prediction model generation section 13. The contribution degree calculation section 11 calculates, with use of a test data set different from a training data set used in training of a prediction model to be tested, a degree of contribution of each of a plurality of features to a prediction result, a value of the each of the plurality of features being inputted to the prediction model to be tested. The feature selection section 12 selects at least one feature from among the plurality of features on the basis of a degree of contribution of each of the plurality of features. The prediction model generation section 13 generates a new prediction model which, upon receiving input of a value of the at least one feature selected, outputs a prediction result.

### Program Implementation Example

In a case where the prediction model generation apparatus 1 is constituted by a computer, the following program in accordance with the present example embodiment is stored in a memory of the computer. The program causes the computer to function as: the contribution degree calculation section 11 that calculates, with use of a test data set different from a training data set used in training of a prediction model to be tested, a degree of contribution of each of a plurality of features to a prediction result, a value of the each of the plurality of features being inputted to the prediction model to be tested; the feature selection section 12 that selects, on the basis of the degree of contribution of the each of the plurality of features, at least one feature from among the plurality of features; and the prediction model generation section 13 that generates a new prediction model which, upon receiving input of a value of the at least one feature selected, outputs a prediction result.

(Flow of Prediction Model Generation Method S1)

The prediction model generation apparatus 1 configured as described above carries out a prediction model generation method S1 in accordance with the present example embodiment. The following will discuss a flow of the prediction model generation method S1 with reference to FIG. 2. FIG. 2 is a flowchart illustrating a flow of the prediction model generation method S1. As illustrated in FIG. 2, the prediction model generation method S1 includes a contribution degree calculation step S11, a feature selection step S12, and a prediction model generation step S13. In the contribution degree calculation step S11, the contribution degree calculation section 11 calculates, with use of a test data set different from a training data set used in training of a prediction model to be tested, a degree of contribution of each of a plurality of features to a prediction result, a value of the each of the plurality of features being inputted to the prediction model to be tested. In the feature selection step S12, the feature selection section 12 selects, on the basis of the degree of contribution of the each of the plurality of features, at least one feature from among the plurality of features. In the prediction model generation step S13, the prediction model generation section 13 generates a new prediction model which, upon receiving input of a value of the at least one feature selected, outputs a prediction result.

### Example Advantage of Present Example Embodiment

As described above, the prediction model generation apparatus 1, the program, and the prediction model generation method S1 in accordance with the present example embodiment employ a configuration of: calculating, with use of a test data set different from a training data set used in training of a prediction model to be tested, a degree of contribution of each of a plurality of features to a prediction result, values of the plurality of features being inputted to the prediction model to be tested; selecting, on the basis of the degree of contribution of the each of the plurality of features, at least one feature from among the plurality of features; and generating a new prediction model which, upon receiving input of a value of the at least one feature selected, outputs a prediction result. The configuration makes it possible to generate a prediction model which not only is capable of reducing a calculation load in a prediction phase but also has a good interpretability.

### Second Example Embodiment

The following will discuss in detail a second example embodiment of the present invention, with reference to drawings. Note that components having the same functions as those described in the first example embodiment are denoted by the same reference numerals, and a description thereof will be omitted accordingly.

(Functional Configuration of Prediction Model Generation Apparatus 10)

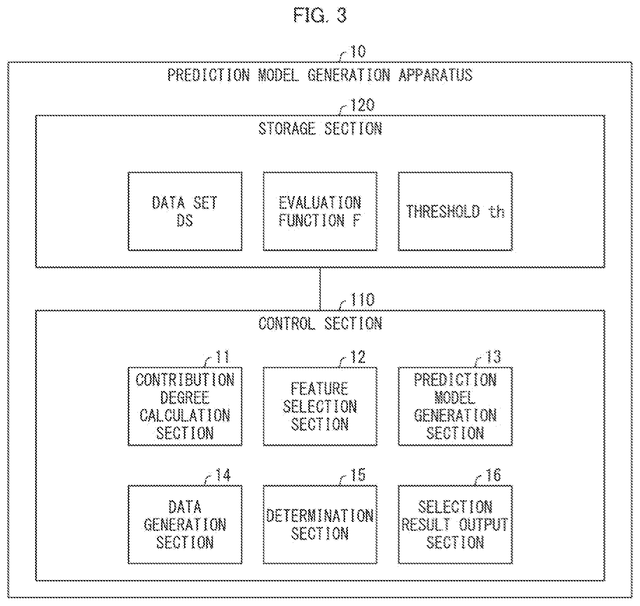

The following will discuss a configuration of a prediction model generation apparatus 10 in accordance with the second example embodiment of the present invention, with reference to FIG. 3. FIG. 3 is a block diagram illustrating a functional configuration of the prediction model generation apparatus 10. As illustrated in FIG. 3, the prediction model generation apparatus 10 includes a control section 110 and a storage section 120. The control section 110 collectively controls sections of the prediction model generation apparatus 10. The control section 110 includes a contribution degree calculation section 11, a feature selection section 12, a prediction model generation section 13, a data generation section 14, a determination section 15, and a selection result output section 16. The storage section 120 stores therein various data used by the control section 110. For example, the storage section 120 stores therein a data set DS, an evaluation function F, and a threshold th.

The data set DS includes a plurality of pieces of data and prediction labels respectively associated with the plurality of pieces of data. Each piece of data includes respective values of N features (N is a natural number of 2 or more). The number N of features whose values are included in the data set DS can be changed by a feature reduction process which will be described later. The data set DS is divided into M portions for cross-validation (M is a natural number of 2 or more). In other words, the data set DS consists of M data sets DS-i (i=1, 2, . . . , M).

The evaluation function F is a function from which an evaluation value for performance evaluation of a prediction model is calculated. For example, a well-known evaluation function can be employed as the evaluation function F. Examples of the evaluation function F include, but are not limited to, a function from which an accuracy is calculated, a function from which a precision is calculated, and a function from which a negative log loss is calculated. The evaluation function F can be stored in the storage section 120 in advance or can be inputted from an input device (not illustrated).

The threshold th is a value of degree of contribution used for determining whether or not to select a feature. The threshold th can be stored in the storage section 120 in advance or can be inputted from an input device (not illustrated).

The contribution degree calculation section 11 calculates, with use of a test data set different from a training data set used in training of a prediction model ML-i to be tested, a degree of contribution of each of the N features to a prediction result. The prediction model ML-i is a model which outputs a prediction result upon receiving input of values of the N features. Note that the prediction model ML-i is generated by the prediction model generation section 13 (described later) with use of the training data set. The training data set used in the training of the prediction model ML-i includes all, except a data set DS-i, of the data sets DS-1 to DS-M. The test data set that is used to test the prediction model ML-i is the data set DS-i. That is, the contribution degree calculation section 11 and the prediction model generation section 13 divide the data set DS into M portions and carry out cross-validation.

The contribution degree calculation section 11 thus carries out, for each of the M data sets DS-i, calculation of respective degrees of contribution of N features per data set DS-i. Thus, M degrees of contribution are calculated for each of the N features. In other words, the contribution degree calculation section 11 calculates, for each feature, M degrees of contribution with use of M test data sets (data sets DS-1 to DS-M). A specific example of the method of calculating degrees of contribution will be described in “Flow of prediction model generation method S10” (described later).

The feature selection section 12 selects, on the basis of the degrees of contribution of each feature, at least one feature from among the N features. Specifically, the feature selection section 12 selects a feature with respect to which a statistic obtained from the M degrees of contribution satisfies a predetermined condition. The number of features selected can be one, or more than one. In a case where there is no feature with respect to which the predetermined condition is satisfied, no feature is selected. A specific example of the predetermined condition will be described in “Flow of prediction model generation method S10” (described later).

The prediction model generation section 13 generates a prediction model ML-i which, upon receiving input of values of the N features, outputs a prediction result. Examples of an algorithm used in training of the prediction model ML-i include, but are not limited to, random forests, gradient boosting decision tree, neural networks, and support vector machines. Suppose that (i) the number N of features in an initial state of the data set DS is NO and (ii) the number N of features in a state after a k-th feature reduction process is carried out as described later is Nk. Then, a prediction model ML-i that receives input of values of Nk features (k=0, 1, . . . ) is an example of a “prediction model to be tested”, and a prediction model ML-i that receives input of values of N(k+1) features is an example of a “new prediction model”. In a case where the feature reduction process is finished after being carried out for the n-th time, the prediction model generation section 13 generates an ultimate prediction model ML which receives input of values of Nn features. The ultimate prediction model ML is also an example of the “new prediction model”. Note that Nk is simply referred to as N in a case where Nk does not need to be particularly distinguished.

The data generation section 14 divides the data set DS into M data sets DS-i. Further, the data generation section 14 updates the data set DS by carrying out the feature reduction process, in which a value(s) of a feature(s) other than the at least one feature selected is/are deleted from each piece of data included in the data set DS. The determination section 15 determines whether or not a result of selection by the feature selection section 12 satisfies an end condition. The selection result output section 16 outputs the result of selection by the feature selection section 12 to an output apparatus (not illustrated) or the like.

(Flow of Prediction Model Generation Method S10)

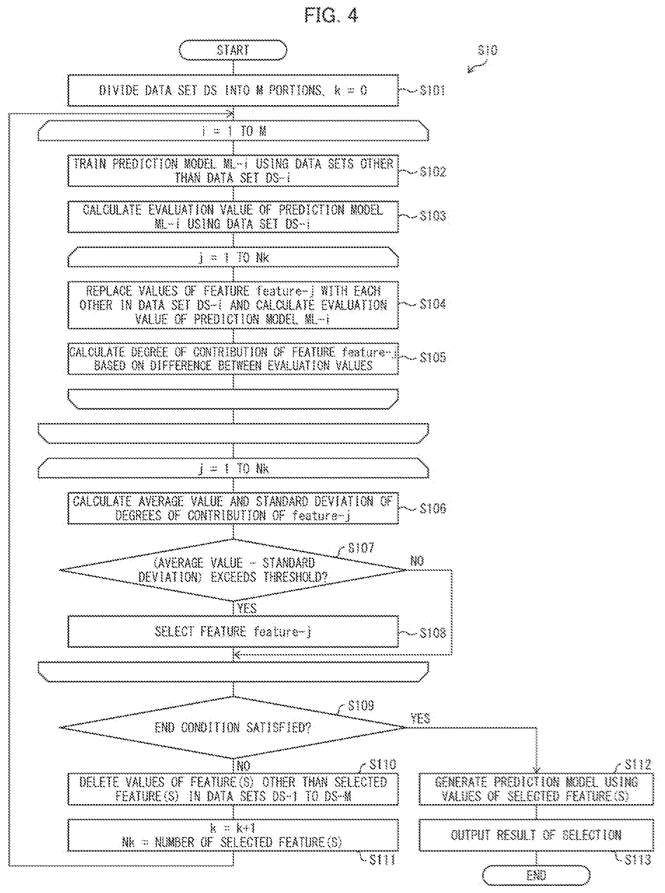

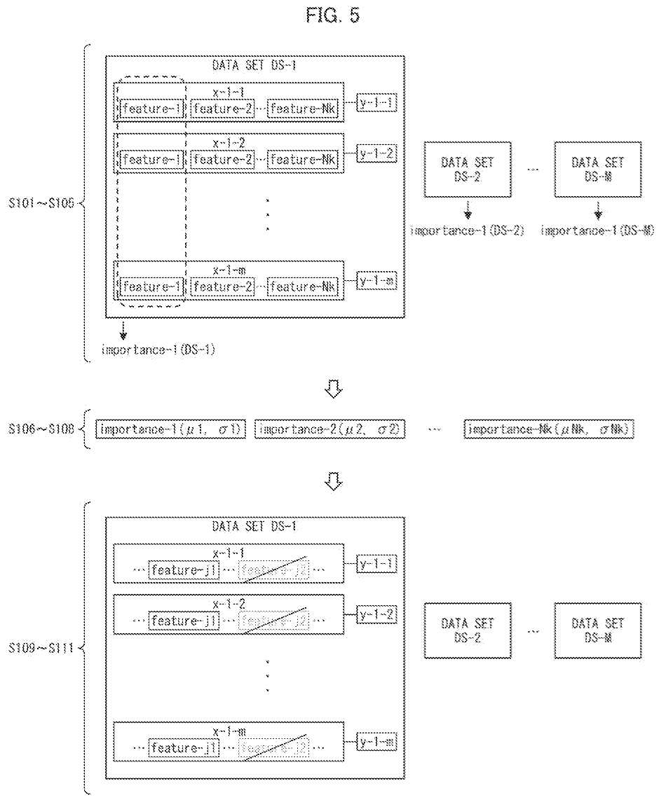

The prediction model generation apparatus 10 configured as described above carries out a prediction model generation method S10 in accordance with the present example embodiment. The following will discuss a flow of the prediction model generation method S10 with reference to FIGS. 4 and 5. FIG. 4 is a flowchart illustrating a flow of the prediction model generation method S10. FIG. 5 is a view schematically illustrating each step of the prediction model generation method S10. As illustrated in FIG. 4, the prediction model generation method S10 includes steps S101 to S113.

In the step S101, the data generation section 14 divides the data set DS into M data sets DS-1, DS-2, . . . , and DS-M. The data generation section 14 also sets the number k of times the feature reduction process has been carried out to zero.

As illustrated in FIG. 5, the data set DS-1 includes m pieces of data x-1-1, x-1-2, . . . , and x-1-m (m is an integer of 2 or more) and prediction labels y-1-1, y-1-2, . . . , and y-1-m respectively associated with the pieces of data x-1-1, x-1-2, . . . , and x-1-m. Each of the pieces of data includes respective values of Nk features feature-j (j=1, 2, . . . , Nk). In FIG. 5, details are illustrated only with respect to the data set DS-1. Note, however, that the other data sets DS-i are described similarly as the data set DS-1. That is, the data set DS-i includes (i) m pieces of data x-i-1, x-i-2, . . . , and x-i-m each of which includes respective values of Nk features feature-j and (ii) prediction labels y-i-1, y-i-2, . . . , and y-i-m respectively associated with the pieces of data x-i-1, x-i-2, . . . , and x-i-m. In the example illustrated, the number of pieces of data included is the same among the data sets DS-i (m pieces each). Note, however, that the number of pieces of data included can be different among at least two data sets DS-i1 and DS-i2 (i1, i2=1, 2, . . . , M; i1≠i2).

Subsequently, the control section 110 repeats the steps S102 through S105 illustrated in FIG. 4, for each of the divided M data sets DS-i. In the step S102, the prediction model generation section 13 trains the prediction model ML-i with use of data sets other than the data set DS-i. Here, for example, in a case where i=1, the “data sets other than the data set DS-1” are data sets DS-2, DS-3, . . . , and DS-M. In a case where i=2, the “data sets other than the data set DS-2” are data sets DS-1, DS-3, . . . , and DS-M. Since values of Nk features feature-j are included in the data set DS, the prediction model ML-i generated in the present step is a model which, upon receiving input of values of Nk features feature-j, outputs a prediction result.

In the step S103, the contribution degree calculation section 11 uses the data set DS-i to calculate an evaluation value of the prediction model ML-i on the basis of the evaluation function F. Specifically, the contribution degree calculation section 11 calculates an evaluation value f1 with use of the evaluation function F, on the basis of m prediction results which are obtained by inputting, to the prediction model ML-i, m pieces of data included in the data set DS-i.

Subsequently, the control section 110 repeats the steps S104 and S105 for each of the Nk features feature-j. In the step S104, the contribution degree calculation section 11 changes a value of feature-j included in each piece of data in the data set DS-i. For example, the contribution degree calculation section 11 can randomly replace values of a feature feature-j with each other among the m pieces of data included in the data set DS-i to thereby change the values of the feature feature-j. For example, in a case where i=1 and j=1, the contribution degree calculation section 11 replaces the values of a feature feature-1 with each other in the data set DS-1, as indicated by a rectangle drawn in a broken line in FIG. 5. Note that the method for changing the values of the feature-j is not limited to random replacement but can be any other method.

Subsequently, the contribution degree calculation section 11 calculates, with use of the data set DS-i in which the values of the feature feature-j have been changed, an evaluation value f2 of the prediction model ML-i on the basis of the evaluation function F. Details of the calculation of the evaluation value f2 are similar to the above-described details of the calculation of the evaluation value f1 in the step S103

In the step S105, the contribution degree calculation section 11 calculates a degree of contribution importance-j (DS-i) of the feature feature-j on the basis of a difference between the evaluation value f1 and the evaluation value f2. The evaluation value f1 is an evaluation value of the prediction model ML-i corresponding to a case in which the values of the feature-j are not changed. The evaluation value f1 is a value calculated in the step S103. The evaluation value f2 is an evaluation value of the prediction model ML-i corresponding to a case in which the values of the feature-j are changed. The evaluation value f2 is a value calculated in the step S104. For example, the contribution degree calculation section 11 can directly use the difference between the evaluation value f1 and the evaluation value f2 as a degree of contribution, or can use, as a degree of contribution, a value obtained by normalization of the difference between the evaluation values. The degree of contribution importance-1 (DS-1) illustrated in FIG. 5 represents a degree of contribution obtained from a difference between (i) an evaluation value f2 calculated with use of a data set DS-1 in which the values of feature-1 have been replaced with each other and (ii) an evaluation value f1 calculated with use of a data set DS-1 in which the values of feature-1 have not been replaced with each other.

In a case where the steps S104 and S105 are finished with respect to all of the Nk features feature-j with use of a relevant data set DS-i, Nk degrees of contribution, namely, importance-1 (DS-i), importance-2 (DS-i), and importance-Nk (DS-i) have been calculated. The control section 110 repeats the steps S102 through S105 with use of the next data set DS-i. In a case where the steps S102 through S105 are finished with respect to all of the M data sets DS-i, M degrees of contribution, namely, importance-1 (DS-1), importance-1 (DS-2), . . . , and importance-1 (DS-M) have been calculated for the feature feature-1. With respect to each of the other features feature-j, M degrees of contribution have been similarly calculated.

Subsequently, the control section 110 repeats the steps S106 through S108 illustrated in FIG. 4 for each of the Nk features feature-j. In the step S106, the feature selection section 12 calculates, with respect to a certain feature feature-j, an average value μj and a standard deviation σj on the basis of M degrees of contribution. For example, as illustrated in FIG. 5, an average value μ1 and a standard deviation of are calculated with respect to the feature feature-1.

In the step S107 illustrated in FIG. 4, the feature selection section 12 determines whether or not a value obtained by subtracting the standard deviation σj from the average value μj is not less than the threshold th. In a case where the feature selection section 12 determines Yes in the step S107, the step S108 is carried out. In the step S108, the feature selection section 12 selects the certain feature feature-j. In FIG. 5, the selected certain feature feature-j is indicated as a feature feature-j1. For example, the feature selection section 12 causes information indicative of the feature feature-j1 to be stored in the storage section 120 as a result of selection. Then, the feature selection section 12 repeats the processes from the step S106, with respect to the next feature feature-j. In a case where the feature selection section 12 determines No in the step S107, the step S108 is not carried out, but the processes from the step S106 are repeated with respect to the next feature feature-j. That is, in this case, the certain feature feature-j is not selected. In FIG. 5, the unselected certain feature feature-j is indicated as a feature feature-j2.

In a case where repeating of the steps S106 through S108 in FIG. 4 is finished with respect to all of the Nk feature feature-j, a result of selection has been stored in the storage section 120. The result of selection may include information indicative of selected one or more features feature-j1, or may include no such information.

In the step S109, the determination section 15 determines whether or not the result of selection satisfies an end condition. The end condition, for example, includes a condition that the result of selection includes no feature feature-j1. Further, the end condition, for example, includes a condition that the number of features feature-j1 included in the result of selection is Nk (in other words, the result of selection includes no feature feature-j2, which is an unselected feature).

A case in which the determination section 15 determines Yes in the step S109 will be described later. In a case where the determination section 15 determines No in the step S109, the step S110 is carried out. In the step S110, the data generation section 14 deletes, in the data set DS, the values of feature(s) other than the feature(s) feature-j 1 which has/have been selected. For example, as illustrated in FIG. 5, the data generation section 14 deletes the values of the feature feature-j2, which has not been selected, in each of the data sets DS-1, DS-2, . . . , and DS-M. Thus, the data sets DS-1, DS-2, . . . , and DS-M are each updated so as to include only the values of the selected feature(s) feature-j1.

In the step S111, the control section 110 adds one (1) to the number k of times the feature reduction process has been carried out. That is, carrying out the above-described steps S102 through S108 is equivalent to carrying out the feature reduction process once. Then, the control section 110 sets the number Nk of features to the number of the selected feature(s) feature-j1, and repeats the processes from the step S102. In the next step S102, a prediction model ML-i that receives input of values of Nk features is generated, the Nk features being as of after the (k-1)th feature reduction process is carried out. This prediction model ML-i is an example of the “new prediction model”. Further, the processes from the step S103 are subsequently carried out, so that the contribution degree calculation section 11, the feature selection section 12, and the prediction model generation section 13 function again with use of the new prediction model ML-i as a prediction model to be tested.

In a case where the determination section 15 determines Yes in the step S109, the step S112 is carried out. In the step S112, the prediction model generation section 13 generates an ultimate prediction model ML. For example, the prediction model generation section 13 can specify, as the ultimate prediction model ML, a prediction model ML-i that has the highest evaluation value f1 among prediction models ML-1 through ML-M generated in a step S102 most recently carried out.

Further, the prediction model generation section 13 can specify, as the ultimate prediction model ML, a configuration in which a single prediction result is outputted on the basis of a plurality of outputs obtained with use of all or part of the prediction models ML-1 through ML-M generated in the step S102 most recently carried out. In other words, the prediction model generation section 13 can specify, as the ultimate prediction model ML, an ensemble of all or part of the prediction models ML-1 through ML-M. For example, in a case where the prediction models ML-1 through ML-M are regression models, the ultimate prediction model ML can be a model that outputs an average of respective outputs from the prediction models ML-1 through ML-M. Further, in a case where the prediction models ML-1 through ML-M are classification models, the ultimate prediction model ML can be a model that outputs a classification result on the basis of an average of respective prediction probabilities outputted from the prediction models ML-1 through ML-M.

Further, the prediction model generation section 13 can newly generate the ultimate prediction model ML with use of another data set that is different from the data set DS and only contains values of the selected feature(s) feature-j1.

In the step S113, the selection result output section 16 outputs the result of selection to an output apparatus (not illustrated). For example, the selection result output section 16 can output information indicative of the ultimately selected feature(s) feature-j1. Further, for example, the selection result output section 16 can output information indicative of all of the unselected features feature-j2. Examples of outputted “information indicative of a feature” include, but are not limited to, a name of the feature.

### Example Advantage of Present Example Embodiment

The present example embodiment employs a configuration in which, in a case where the number of features selected is more than one, the contribution degree calculation section 11, the feature selection section 12, and the prediction model generation section 13 function again with use of a new prediction model as a prediction model to be tested, the new prediction model being generated with use of a data set DS in which values of a feature(s) other than the selected features have been deleted. The configuration makes it possible to narrow down to features that are more reliably likely to contribute to a prediction result.

Further, the present example embodiment employs a configuration in which a degree of contribution of each feature is calculated on the basis of a difference between (i) an evaluation value f2 of a prediction model to be tested corresponding to a case in which values of the each feature are changed in a data set DS-i used in the test and (ii) an evaluation value f1 of the prediction model to be tested corresponding to a case in which the values of the each feature are not changed in the data set DS-i. The configuration makes it possible to calculate a degree of contribution accurately in accordance with an effect of the change of the values of the each feature.

Further, the present example embodiment employs a configuration in which the values of the each feature are changed such that the values of the each feature are randomly replaced with each other among a plurality of pieces of data included in the data set DS-i used in the test. With the configuration, a process of changing values of a feature in order to calculate a degree of contribution can be easily carried out.

Further, the present example embodiment employs a configuration of calculating a plurality of degrees of contribution of each feature with use of a plurality of data sets DS-i and selecting a feature with respect to which a statistic obtained from the plurality of degrees of contribution satisfies a predetermined condition. The configuration makes it possible to select a feature accurately on the basis of a plurality of degrees of contribution.

Further, the present example embodiment employs a configuration in which the following condition is applied as the predetermined condition: a value obtained by subtracting a standard deviation of the plurality of degrees of contribution from an average value of the plurality of degrees of contribution is not less than a threshold. With the configuration, a possibility that values of a feature that does not actually contribute to the prediction result very much have not been deleted can be reduced in comparison to, for example, a case in which the average value is compared with a threshold. Further, a possibility that values of a feature that actually contributes to the prediction result are undesirably deleted can be reduced in comparison to, for example, a case in which a value obtained by subtracting, from the average value, a value that is double the standard deviation is compared with a threshold. That is, it is possible to narrow down to features that contribute to a prediction result.

### Variation of Present Example Embodiment

The second example embodiment has been described such that the data set DS is used to carry out cross-validation. The present example embodiment is not limited to this, and the prediction model generation apparatus 10 can calculate, with use of data sets DS1 to DS-M, a plurality of degrees of contribution of a prediction model ML which has been trained with use of a data set for training, which is different from the data set DS. In this case, the data generation section 14 can carry out the feature reduction process with respect to the data set for training and the data set DS and then carry out the next repeating.

Further, the second example embodiment has been described such that a value obtained by subtracting the standard deviation from the average value is used as the statistic. However, the statistic in accordance with the present example embodiment is not limited to this and can be other statistics. Further, the second example embodiment has been described such that the following condition is used as the predetermined condition: a value obtained by subtracting the standard deviation from the average value is not less than the threshold th. However, the predetermined condition is not limited to this. Examples of the predetermined condition include: a condition that the feature is among the top predetermined number of features ranked in descending order of statistics among all features; and other conditions.

### Third Example Embodiment

The following will discuss in detail a prediction apparatus 20 in accordance with a third example embodiment of the present invention, with reference to drawings. The prediction apparatus 20 is an apparatus which carries out prediction with use of a prediction model ML generated by the prediction model generation apparatus 1 or 10. The system disclosed in Patent Literature 1 described above has the problem of a high calculation load in calculation of values of a large number of features to be inputted to the prediction model in a prediction phase. The prediction apparatus 20 in accordance with the present example embodiment can solve the problem by using prediction model ML described above, and can achieve a reduction in calculation load of feature values in a prediction phase. Note that any constituent element that is identical in function to a constituent element described in the first example embodiment or the second example embodiment will be given the same reference numeral, and a description thereof will not be repeated.

(Configuration of Prediction Apparatus 20)

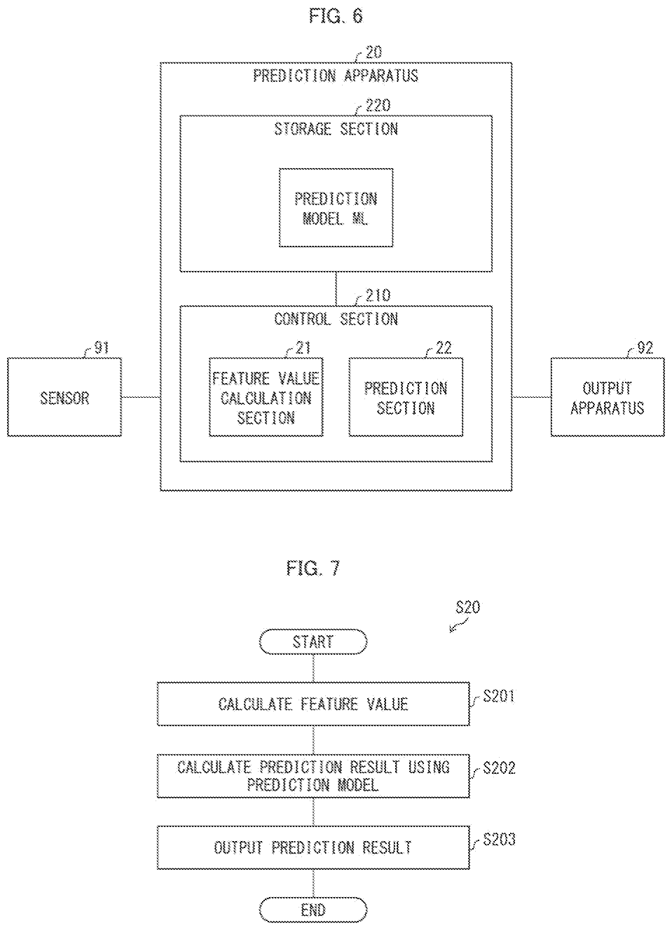

The following will discuss a configuration of the prediction apparatus 20, with reference to FIG. 6. FIG. 6 is a block diagram illustrating a configuration of the prediction apparatus 20. As illustrated in FIG. 6, the prediction apparatus 20 is communicatively connected to a sensor 91 and an output apparatus 92. The sensor 91 obtains sensor information from a target of prediction. The output apparatus 92 outputs information outputted from the prediction apparatus 20 The prediction apparatus 20 outputs, to the output apparatus 92 in real time, a prediction result related to the target of prediction on the basis of, for example, sensor information inputted from the sensor 91 in real time.

As illustrated in FIG. 6, the prediction apparatus 20 includes a control section 210 and a storage section 220. The control section 210 collectively controls sections of the prediction apparatus 20. Further, the control section 210 includes a feature value calculation section 21 and a prediction section 22. The storage section 220 stores therein various data used by the control section 210. For example, the storage section 220 stores therein a prediction model ML. The prediction model ML is a prediction model generated by the prediction model generation apparatus 1 in accordance with the first example embodiment or the prediction model generation apparatus 10 in accordance with the second example embodiment.

The feature value calculation section 21 calculates, on the basis of information obtained from the target of prediction, a value of a selected feature. The information obtained from the target of prediction is, for example, sensor information obtained from the sensor 91. The prediction section 22 inputs, to the prediction model ML, the calculated value of the feature to thereby output a prediction result related to the target of prediction.

### Program Implementation Example

In a case where the prediction apparatus 20 is constituted by a computer, the following program in accordance with the present example embodiment is stored in a memory of the computer. The program causes the computer to function with use of the prediction model ML generated by the prediction model generation apparatus 1 or 10, the program causing the computer to function as: the feature value calculation section 21 which calculates, on the basis of information obtained from the target of prediction, a value of at least one selected feature; and the prediction section 22 which inputs, to the prediction model ML, the calculated value of the at least one feature to thereby output a prediction result related to the target of prediction.

(Flow of Prediction Method S20)

The prediction apparatus 20 configured as described above carries out a prediction method S20 in accordance with the present example embodiment. The following will discuss a flow of the prediction method S20 with reference to FIG. 7. FIG. 7 is a flowchart illustrating a flow of the prediction method S20. As illustrated in FIG. 7, the prediction method S20 includes steps S201 to S203.

In the step S201, the feature value calculation section 21 calculates, on the basis of information obtained from the target of prediction, a value of at least one selected feature. As the information obtained from the target of prediction, sensor information inputted from the sensor 91 is referred to. The at least one selected feature is an at least one feature whose values are to be inputted to the prediction model ML and which is selected by the prediction model generation apparatus 1 in accordance with the first example embodiment or the prediction model generation apparatus in accordance with the second example embodiment.

In the step S202, the prediction section 22 inputs, to the prediction model ML, the calculated value of the at least one feature to thereby obtain a prediction result outputted from the prediction model ML. In the step S203, the prediction section 22 outputs the prediction result to the output apparatus 92. For example, the prediction section 22 can cause the prediction result to be displayed on a display (an example of the output apparatus 92). Note that the output apparatus 92 is not limited to the display, but can be a speaker, a printer, a light emitting diode (LED) lamp, or the like.

### Example Advantage of Present Example Embodiment

The present example embodiment employs a configuration of calculating, on the basis of sensor information obtained from a target of prediction, a value of at least one feature selected by the prediction model generation apparatus 1 or 10; and inputting, to the prediction model ML generated by the prediction model generation apparatus 1 or 10, the calculated value of the at least one feature to thereby output a prediction result related to the target of prediction. The configuration makes it possible to narrow down the features whose values are to be calculated from the sensor information. This makes it possible to reduce a load in calculation of feature values. The configuration also reduces a load in calculation of a prediction result by the prediction model ML. As such, it is possible to (i) reduce a length of time from a time point when sensor information is obtained to a time point when feature values are inputted to the prediction model ML and (ii) reduce a length of time until a prediction result is ultimately outputted from the prediction model ML. This improves the real-timeness in which a prediction result is obtained with respect to a target of prediction.

### Example of Application of Second and Third Example Embodiments

The following will discuss an application example in which the prediction model generation apparatus 10 in accordance with the second example embodiment and the prediction apparatus 20 in accordance with the third example embodiment are used to predict a worrying condition (an event to be predicted) of a patient (a target of prediction). First, the prediction model generation apparatus 10 generates, with use of a data set DS, an ultimate prediction model ML for predicting a worrying condition of the patient. As the data set DS, a data set including a plurality of pieces of data has been prepared. In each of the plurality of pieces of data, a large number of feature values pertaining to a heartbeat and an acceleration of the patient are associated with a worrying label (an example of the prediction label) that indicates whether or not the patient is in a worrying condition. The feature values pertaining to the heartbeat and the acceleration have been calculated from sensor information obtained by measurements carried out by a heartbeat sensor and an acceleration sensor which are worn by the patient. In the present application example, the factor contributing to the worrying condition of the patient is unclear, and thus approximately 500 features are used as features that can be a factor. A negative log loss is employed as the evaluation function F. The value zero is employed as the threshold th.

In a case where the prediction model generation apparatus 10 carried out the prediction model generation method S10 with use of the data set DS as described above, the number of features ultimately selected was approximately 15. For example, “an average of heartbeat intervals in 16 windows”, which was one of the features whose values were included in the initial data set DS, was not selected based on a decision NO in the step S107. That is, it was determined that this feature had a low degree of contribution to prediction of the worrying condition of the patient, and values of the feature were therefore deleted. Thus generated in the step S112 was a prediction model ML which, upon receiving input of values of approximately 15 ultimately selected features, outputted a prediction result of the worrying condition. This prediction model ML has an excellent interpretability because the approximately 15 features inputted can be interpreted to contribute to the worrying condition.

The prediction apparatus 20 predicts the worrying condition of the patient with use of the prediction model ML. The sensor 91 (the heartbeat sensor and the acceleration sensor) are worn by the patient, who is a target of prediction. The output apparatus 92, for example, is a display. Upon receiving input of sensor information from the sensor 91 worn by the patient, the prediction apparatus 20 calculates values of approximately 15 features from the sensor information, inputs the calculated values of the features to the prediction model ML to obtain a prediction result of the worrying condition, and outputs the prediction result. The present application example makes it possible to significantly reduce a length of time from a time point when the sensor information is inputted to a time point when the prediction result of the worrying condition is outputted, in comparison to a case in which values of features are not reduced (a case in which values of approximately 500 features are calculated).

### Software Implementation Example

Some or all of the functions of the prediction model generation apparatuses 1 and 10 and the prediction apparatus 20 (hereinafter referred to as “devices”) can be realized by hardware such as an integrated circuit (IC chip) or can be alternatively realized by software.

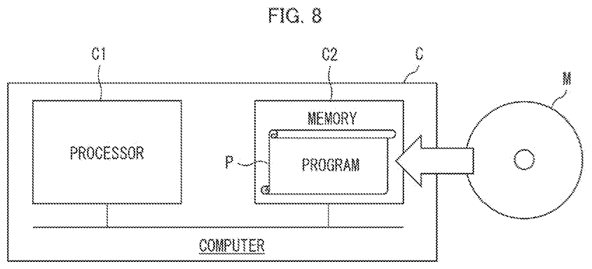

In the latter case, the apparatuses are realized by, for example, a computer that executes instructions of a program that is software realizing the foregoing functions. FIG. 8 illustrates an example of such a computer (hereinafter, referred to as “computer C”). The computer C includes at least one processor C1 and at least one memory C2. In the memory C2, a program P for causing the computer C to operate as the devices is stored. In the computer C, the foregoing functions of the devices can be realized by the processor C1 reading and executing the program P stored in the memory C2.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display, and a printer.

The program P can be stored in a non-transitory tangible storage medium M that can be read by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as, but not limited to, the following supplementary notes.

(Supplementary Note 1)

A prediction model generation apparatus, including:
a contribution degree calculation means that calculates, with use of a test data set different from a training data set used in training of a prediction model to be tested, a degree of contribution of each of a plurality of features to a prediction result, a value of the each of the plurality of features being inputted to the prediction model to be tested;
a feature selection means that selects, on the basis of the degree of contribution of the each of the plurality of features, at least one feature from among the plurality of features; and a prediction model generation means that generates a new prediction model which, upon receiving input of a value of the at least one feature selected, outputs a prediction result.

(Supplementary Note 2)

The prediction model generation apparatus as set forth in supplementary note 1, wherein in a case where the at least one feature selected is more than one feature, the contribution degree calculation means, the feature selection means, and the prediction model generation means function again with use of the new prediction model as a prediction model to be tested.

(Supplementary Note 3)

The prediction model generation apparatus as set forth in supplementary note 1 or 2, wherein the degree of contribution of the each of the plurality of features is calculated by the contribution degree calculation means on the basis of a difference between (i) an evaluation value of the prediction model to be tested corresponding to a case in which the value of the each of the plurality of features is changed in the test data set and (ii) an evaluation value of the prediction model to be tested corresponding to a case in which the value of the each of the plurality of features is not changed in the test data set.

(Supplementary Note 4)

The prediction model generation apparatus as set forth in supplementary note 3, wherein the contribution degree calculation means changes the value of the each of the plurality of features such that values of the each of the plurality of features are randomly replaced with each other among a plurality of pieces of data included in the test data set.

(Supplementary Note 5)

The prediction model generation apparatus as set forth in any one of supplementary notes 1 to 3, wherein:
the contribution degree calculation means calculates a plurality of the degrees of contribution for the each of the plurality of features with use of a plurality of the test data sets; and
the feature selection means selects a feature with respect to which a statistic obtained from the plurality of the degrees of contribution satisfies a predetermined condition.

(Supplementary Note 6)

The prediction model generation apparatus as set forth in supplementary note 5, wherein the feature selection means applies the following condition as the predetermined condition: a value obtained by subtracting a standard deviation of the plurality of the degrees of contribution from an average value of the plurality of the degrees of contribution is not less than a threshold.

(Supplementary Note 7)

A prediction apparatus which uses the new prediction model generated by the prediction model generation apparatus recited in any one of supplementary notes 1 to 6, the prediction apparatus includes:
a feature value calculation means that calculates, on the basis of information obtained from a target of prediction, a value of the at least one feature selected; and
a prediction means that inputs, to the new prediction model, the calculated value of the at least one feature to thereby output a prediction result related to the target of prediction.

(Supplementary Note 8)

A prediction model generation method, including:
calculating, with use of a test data set different from a training data set used in training of a prediction model to be tested, a degree of contribution of each of a plurality of features to a prediction result, a value of the each of the plurality of features being inputted to the prediction model to be tested;
selecting, on the basis of the degree of contribution of the each of the plurality of features, at least one feature from among the plurality of features; and
generating a new prediction model which, upon receiving input of a value of the at least one feature selected, outputs a prediction result,
the calculating, the selecting and the generating each being carried out by a computer.

(Supplementary Note 9)

A prediction method carried out by a computer with use of the new prediction model generated by the prediction model generation apparatus recited in supplementary note 1 or 2,
the prediction method including:
calculating, on the basis of information obtained from a target of prediction, a value of the at least one feature selected; and
inputting, to the new prediction model, the calculated value of the at least one feature to thereby output a prediction result related to the target of prediction.

(Supplementary Note 10)

A program which causes a computer to function as:
a contribution degree calculation means that calculates, with use of a test data set different from a training data set used in training of a prediction model to be tested, a degree of contribution of each of a plurality of features to a prediction result, a value of the each of the plurality of features being inputted to the prediction model to be tested;
a feature selection means that selects, on the basis of the degree of contribution of the each of the plurality of features, at least one feature from among the plurality of features; and
a prediction model generation means that generates a new prediction model which, upon receiving input of a value of the at least one feature selected, outputs a prediction result.

(Supplementary Note 11)

A program for causing a computer to function with use of the new prediction model generated by the prediction model generation apparatus recited in supplementary note 1 or 2,
the program causing the computer to function as:
a feature value calculation means that calculates, on the basis of information obtained from a target of prediction, a value of the at least one feature selected; and
a prediction means that inputs, to the new prediction model, the calculated value of the at least one feature to thereby output a prediction result related to the target of prediction.

(Supplementary Note 12)

A prediction model generation apparatus, including at least one processor, the at least one processor carrying out: a contribution degree calculation process of calculating, with use of a test data set different from a training data set used in training of a prediction model to be tested, a degree of contribution of each of a plurality of features to a prediction result, a value of the each of the plurality of features being inputted to the prediction model to be tested; a feature selection process of selecting, on the basis of the degree of contribution of the each of the plurality of features, at least one feature from among the plurality of features; and a prediction model generation process of generating a new prediction model which, upon receiving input of a value of the at least one feature selected, outputs a prediction result.

Note that the prediction model generation apparatus may further include a memory, which may store therein a program for causing the at least one processor to carry out the contribution degree calculation process, the feature value selection process, and the prediction model generation process. Further, the program can be stored in a non-transitory tangible storage medium that can be read by a computer.

(Supplementary Note 13)

A prediction apparatus which uses the new prediction model generated by the prediction model generation apparatus described above, the prediction apparatus including at least one processor that carries out: a feature value calculation process of calculating, on the basis of information obtained from a target of prediction, a value of the at least one feature selected; and a prediction process of inputting, to the new prediction model, the calculated value of the at least one feature to thereby output a prediction result related to the target of prediction.

Note that the prediction apparatus may further include a memory, which may store a program for causing the at least one processor to carry out the feature value calculation process and the prediction process. Further, the program can be stored in a non-transitory tangible storage medium that can be read by a computer.

### REFERENCE SIGNS LIST

1, 10: Prediction model generation apparatus
11: Contribution degree calculation section
12: Feature selection section
13: Prediction model generation section
14: Data generation section
15: Determination section
16: Selection result output section
20: Prediction apparatus
21: Feature value calculation section
22: Prediction section
91: Sensor
92: Output apparatus
110, 210: Control section
120, 220: Storage section
C1: Processor
C2: Memory

1. A prediction model generation apparatus, comprising at least one processor,
the at least one processor carrying out:
a contribution degree calculation process of calculating, with use of a test data set different from a training data set used in training of a prediction model to be tested, a degree of contribution of each of a plurality of features to a prediction result, a value of the each of the plurality of features being inputted to the prediction model to be tested;
a feature selection process of selecting, on the basis of the degree of contribution of the each of the plurality of features, at least one feature from among the plurality of features; and
a prediction model generation process of generating a new prediction model which, upon receiving input of a value of the at least one feature selected, outputs a prediction result.

2. The prediction model generation apparatus as set forth in claim 1, wherein in a case where the at least one feature selected is more than one feature, the at least one processor carries out the contribution degree calculation process, the feature selection process, and the prediction model generation process again with use of the new prediction model as a prediction model to be tested.

3. The prediction model generation apparatus as set forth in claim 1, wherein in the contribution degree calculation process, the degree of contribution of the each of the plurality of features is calculated on the basis of a difference between (i) an evaluation value of the prediction model to be tested corresponding to a case in which the value of the each of the plurality of features is changed in the test data set and (ii) an evaluation value of the prediction model to be tested corresponding to a case in which the value of the each of the plurality of features is not changed in the test data set.

4. The prediction model generation apparatus as set forth in claim 3, wherein in the contribution degree calculation process, the value of the each of the plurality of features is changed such that values of the each of the plurality of features are randomly replaced with each other among a plurality of pieces of data included in the test data set.

5. The prediction model generation apparatus as set forth in claim 1, wherein:
in the contribution degree calculation process, a plurality of the degrees of contribution are calculated for the each of the plurality of features with use of a plurality of the test data sets; and
in the feature selection process, a feature with respect to which a statistic obtained from the plurality of the degrees of contribution satisfies a predetermined condition is selected.

6. The prediction model generation apparatus as set forth in claim 5, wherein in the feature selection process, the following condition is applied as the predetermined condition: a value obtained by subtracting a standard deviation of the plurality of the degrees of contribution from an average value of the plurality of the degrees of contribution is not less than a threshold.

7. A prediction apparatus which uses the new prediction model generated by the prediction model generation apparatus recited in claim 1,
the prediction apparatus comprising at least one processor that carries out:
a feature value calculation process of calculating, on the basis of information obtained from a target of prediction, a value of the at least one feature selected; and
a prediction process of inputting, to the new prediction model, the calculated value of the at least one feature to thereby output a prediction result related to the target of prediction.

8. A prediction model generation method, comprising:
calculating, with use of a test data set different from a training data set used in training of a prediction model to be tested, a degree of contribution of each of a plurality of features to a prediction result, a value of the each of the plurality of features being inputted to the prediction model to be tested;
selecting, on the basis of the degree of contribution of the each of the plurality of features, at least one feature from among the plurality of features; and
generating a new prediction model which, upon receiving input of a value of the at least one feature selected, outputs a prediction result,
the calculating, the selecting and the generating each being carried out by a computer.

9. A prediction method carried out by a computer with use of the new prediction model generated by the prediction model generation apparatus recited in claim 1,
the prediction method comprising:
calculating, on the basis of information obtained from a target of prediction, a value of the at least one feature selected; and
inputting, to the new prediction model, the calculated value of the at least one feature to thereby output a prediction result related to the target of prediction.

10. A non-transitory storage medium storing therein a program for causing a computer to carry out:
a contribution degree calculation process of calculating, with use of a test data set different from a training data set used in training of a prediction model to be tested, a degree of contribution of each of a plurality of features to a prediction result, a value of the each of the plurality of features being inputted to the prediction model to be tested;
a feature selection process of selecting, on the basis of the degree of contribution of the each of the plurality of features, at least one feature from among the plurality of features; and
a prediction model generation process of generating a new prediction model which, upon receiving input of a value of the at least one feature selected, outputs a prediction result.

11. A non-transitory storage medium storing therein a program for causing a computer to function with use of the new prediction model generated by the prediction model generation apparatus recited in claim 1,
the program causing the computer to carry out:
a feature value calculation process of calculating, on the basis of information obtained from a target of prediction, a value of the at least one feature selected; and
a prediction process of inputting, to the new prediction model, the calculated value of the at least one feature to thereby output a prediction result related to the target of prediction.
